(19) United States
(12) Patent Application Publication
(10) Pub. No.: US 2011/0137943 A1
(43) Pub. Date: Jun. 9, 2011

(54) APPARATUS FOR DECIDING WORD-RELATED KEYWORDS, AND METHOD AND PROGRAM FOR CONTROLLING OPERATION OF SAME

(76) Inventor: Motoshige ASANO, Tokyo (JP)

(21) Appl. No.: 12/952,839

(22) Filed: Nov. 23, 2010

(30) Foreign Application Priority Data
Dec. 3, 2009 (JP) 2009-275197

(51) Int. Cl. G06F 17/30

(52) U.S. Cl. 707/780; 707/E17.022

(57) ABSTRACT

A word for which a keyword is desired to be decided is input, and a web page related to the input word is found by a search. Keywords (“programming language”, “object-oriented”, “education”, “seminar”), which are described in a meta tag of the found web page, are extracted. The extracted keywords are transmitted to a dictionary server where a specialized dictionary containing the input word has been registered. If any of these transmitted keywords has been registered at this dictionary server, then this keyword is decided upon as a keyword related to the input word.

### BACKGROUND OF THE INVENTION

1. Field of the Invention

This invention relates to an apparatus for deciding word-related keywords, a method of controlling the operation of this apparatus and a program for controlling the operation of the apparatus.

2. Description of the Related Art

Web pages often employ meta tags that carry descriptions of keywords. When a keyword that has been input to a search engine and a keyword described in a meta tag match, a web page having the meta tag in which the matching keyword is described is displayed as the search result. Further, the specification of Japanese Patent Application Laid-Open No. 2008-310626 discloses the collecting of text that has been tagged, and the specification of Japanese Patent Application Laid-Open No. 2008-21139 discloses a technique for preparing a prescribed tag for every word in advance and then assigning the tags automatically.

However, such techniques cannot always find a keyword that is suited to a web page.

### SUMMARY OF THE INVENTION

An object of the present invention is to decide a keyword that is suited to a web page.

According to a first aspect of the present invention, the foregoing object is attained by providing an apparatus for deciding a word-related keyword, comprising: a word input device (word input means) for inputting a word for finding a related keyword; a word data transmitting device (word data transmitting means) for transmitting word data, which represents the word that has been input from the word input device, to a search engine; a URL data receiving device (URL data receiving means) for receiving URL data indicating a search result from the search engine; a request transmitting device (request transmitting means) for transmitting a request for web page content, which represents a web page having the URL represented by the URL data received by the URL data receiving device, to a web server; a web page content receiving device for receiving the web page content, which has been transmitted from the web server; a keyword extracting device (keyword extracting means) for extracting a keyword, which is described in a meta tag of the web page content, from the web page content received by the web page content receiving device; a determination device (determination means) for determining whether the keyword extracted by the keyword extracting device has been registered at a site of a specialized dictionary, which is a dictionary in the field of the word that has been input from the word input device; and a keyword deciding device (keyword deciding means), responsive to a determination by the determination device that the keyword extracted by the keyword extracting device has been registered at the site of the specialized dictionary, for deciding that the keyword extracted by the keyword extracting device is a keyword of the word that has been input from the word input device.

The first aspect of the present invention also provides an operation control method suited to the above-described apparatus for deciding a word-related keyword. Specifically, the first aspect of the present invention provides a method of controlling operation of an apparatus for deciding a word-related keyword, comprising the steps of: inputting a word for finding a related keyword; transmitting word data, which represents the word that has been input, to a search engine; receiving URL data indicating a search result from the search engine; transmitting a request for web page content, which represents a web page having the URL represented by the URL data received, to a web server; receiving the web page content, which has been transmitted from the web server; extracting a keyword, which is described in a meta tag of the web page content, from the web page content received; determining whether the extracted keyword has been registered at a site of a specialized dictionary, which is a dictionary in the field of the word that has been input; and responsive to a determination that the extracted keyword has been registered at the site of the specialized dictionary, deciding that the extracted keyword is a keyword of the word that has been input.

The first aspect of the present invention further provides a recording medium storing a program for implementing the above-described method of controlling operation of an apparatus for deciding a word-related keyword.

In accordance with the first aspect of the present invention, a word for finding a related keyword is input and a search of the input word is conducted in a search engine. A keyword described in a meta tag of web content having a URL obtained by the search is extracted. If the extracted keyword has been registered at a site of a specialized dictionary in the field of the word that has been input, then this keyword is decided as a keyword related to the word that has been input. Thus a keyword related to the input word can be decided. In particular, if the extracted keyword has not been registered at the site of a specialized dictionary in the field of the word that has been input, then the extracted keyword is not decided upon as a keyword related to the input word. As a result, a keyword in a field identical with that of the input word can be decided upon as a keyword related to the input word.

The determination device includes a dictionary site search device for finding dictionary sites by conducting an AND search in the search engine between the word that has been input from the word input device and the word “lexicon” or “dictionary”. In this case, the determination device would determine whether the keyword has been registered at dictionary sites, which have been found by the dictionary site search device, except at standard English-language dictionary sites and translation dictionary sites among the found dictionary sites.

According to a second aspect of the present invention, the foregoing object is attained by providing an apparatus for deciding a word-related keyword, comprising: a word input device (word input means) for inputting a word for finding a related keyword; a word data transmitting device (word data transmitting means) for transmitting word data, which represents the word that has been input from the word input device, to a search engine; a URL data receiving device (URL data receiving means) for receiving URL data indicating a search result from the search engine; a request transmitting device (request transmitting means) for transmitting a request for web page content, which represents a web page having the URL represented by the URL data received by the URL data receiving device, to a web server; a web page content receiving device for receiving the web page content, which has been transmitted from the web server; a keyword extracting device (keyword extracting means) for extracting a keyword, which is described in a meta tag of the web page content, from the web page content received by the web page content receiving device; a first determination device (first determination means) for determining whether the word that has been input from the word input device and the keyword extracted by the keyword extracting device are in a dependency relationship in text contained in the web page represented by the web page content received by the web page content receiving device; and a keyword deciding device (keyword deciding means), responsive to a determination by the first determination device that the word and keyword are in a dependency relationship, for deciding that the keyword extracted by the keyword extracting device is a keyword of the word that has been input from the word input device.

The second aspect of the present invention also provides an operation control method suited to the above-described apparatus for deciding a word-related keyword. Specifically, the second aspect of the present invention provides a method of controlling operation of an apparatus for deciding a word-related keyword, comprising the steps of: inputting a word for finding a related keyword; transmitting word data, which represents the word that has been input, to a search engine; receiving URL data indicating a search result from the search engine; transmitting a request for web page content, which represents a web page having the URL represented by the URL data received, to a web server; receiving the web page content, which has been transmitted from the web server; extracting a keyword, which is described in a meta tag of the web page content, from the web page content received; determining whether the word that has been input and the extracted keyword are in a dependency relationship in text contained in the web page represented by the web page content received; and responsive to a determination that the word and keyword are in a dependency relationship, deciding that the extracted keyword is a keyword of the word that has been input.

The second aspect of the present invention further provides a recording medium storing a program for implementing the above-described method of controlling operation of an apparatus for deciding a word-related keyword.

In accordance with the second aspect of the present invention as well, a word for finding a related keyword is input and a search of the input word is conducted. A keyword described in a meta tag of web content having a URL obtained by the search is extracted. If the extracted keyword and the word that has been input are in a syntactic dependency relationship in text contained in the received web content, then the keyword is decided upon as a keyword related to the input word. Since a word and a keyword in a dependency relationship are considered to be closely related, a keyword closely related to the input keyword can be decided.

The apparatus may further comprise a second determination device for determining whether the word that has been input from the word input device and the keyword extracted by the keyword extracting device are in a dependency relationship in text contained in a web page of a search result obtained by conducting an AND search in the search engine between the word that has been input from the word input device and the keyword extracted by the keyword extracting device. In this case, the keyword deciding device, in response to a determination by the second determination device that the word and the keyword are in a dependency relationship, would decide that the keyword extracted by the keyword extracting device is a keyword of the word that has been input from the word input device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a keyword deciding system;

FIG. 2 is a block diagram illustrating the electrical configuration of a client computer;

FIGS. 3 and 4 are flowcharts illustrating processing executed by the client computer;

FIG. 5 is a flowchart illustrating processing executed by a search server;

FIG. 6 is a flowchart illustrating processing executed by a web server;

FIG. 7 is a flowchart illustrating processing executed by a dictionary server;

FIG. 8 illustrates a word and keywords;

FIG. 9 illustrates part of an html document;

FIG. 10 is a flowchart illustrating processing executed by the client computer;

FIG. 11 is a flowchart illustrating processing executed by a search server; and

FIG. 12 illustrates part of an html document.

### DESCRIPTION OF THE PREFERRED EMBODIMENTS

Preferred embodiments of the present invention will now be described in detail with reference to the drawings.

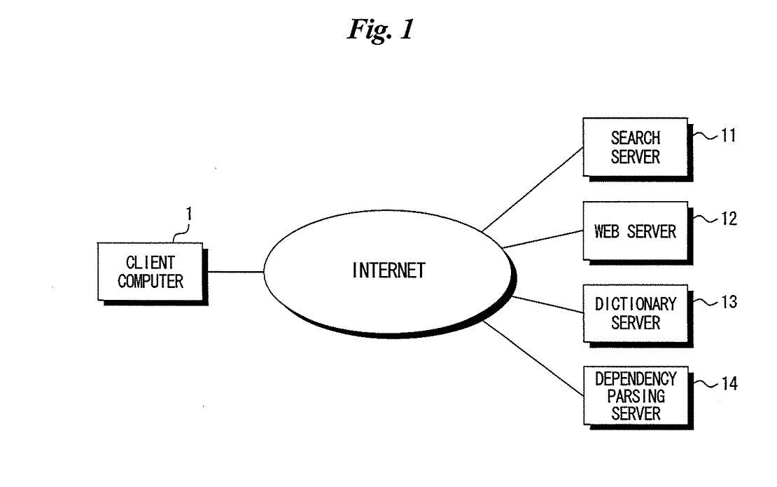

FIG. 1 illustrates an overview of a keyword deciding system according to a first embodiment of the present invention.

The keyword deciding system includes a client computer (device for deciding the keyword of a word) 1, a search server 11, a web server 12, a dictionary server 13 and a dependency parsing server 14. The client computer 1 and servers 11, 12, 13 and 14 are capable of communicating with one another via the Internet.

The search server 11 is a search engine which, in response to application of a word, etc., thereto, conducts a search to find web pages related to the applied word. The web server 12, which stores a large number of items of web page content representing web pages specified by URLs (Uniform Resource Locators), transmits web page content in accordance with a request. The dictionary server 13 stores dictionary data representing the content of a dictionary in which the meanings of words and usages thereof are described. The dependency parsing server 14 is a server for analyzing how a clause (word) and another clause (word) are related.

In FIG. 1, the client computer 1 and servers 11, 12, 13 and 14 are all illustrated as being singular. It goes without saying, however, that a number of client computers 1 and a number of the servers 11, 12, 13 and 14 may exist.

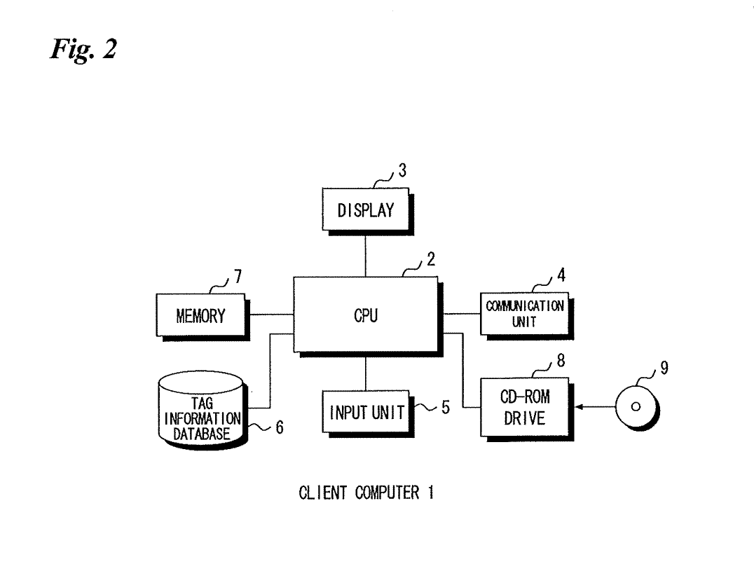

FIG. 2 is a block diagram illustrating the electrical configuration of the client computer 1.

The overall operation of the client computer 1 is controlled by a CPU 2.

The client computer 1 includes a display unit 3; a communication unit 4 for communicating with the Internet; an input unit 5 such as a keyboard and mouse; a tag information database (hard disk) 6 for storing word-related keywords as tag information, as will be described later; a memory 7 for storing prescribe data; and a CD-ROM (Compact Disk—Read-Only Memory) drive 8. A CD-ROM 9 stores an operation program for performing an operation described later. By reading the operation program from the CD-ROM 9 using the CD-ROM drive 8, the read operation program is installed in the client computer 1.

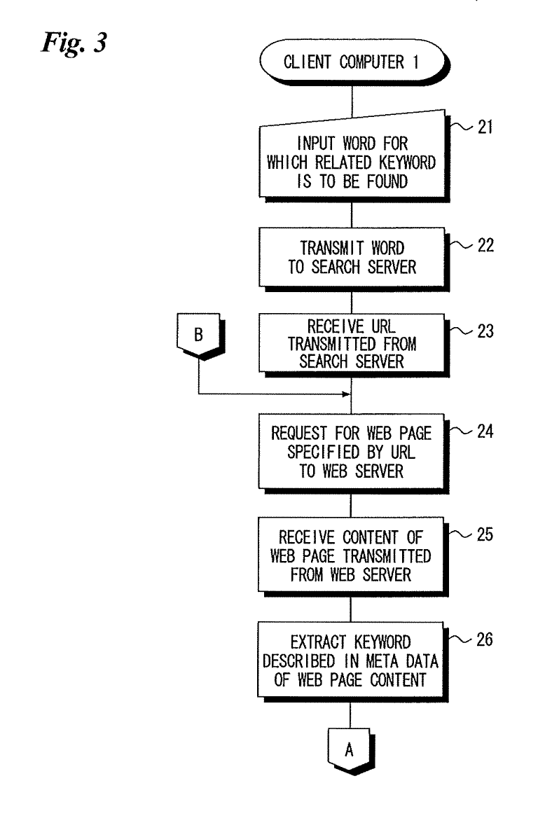

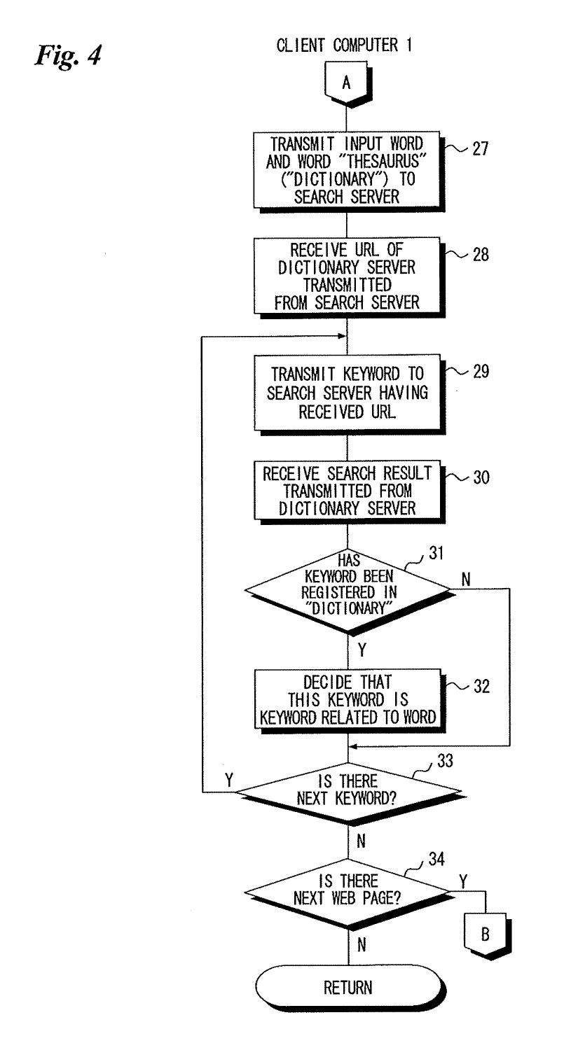

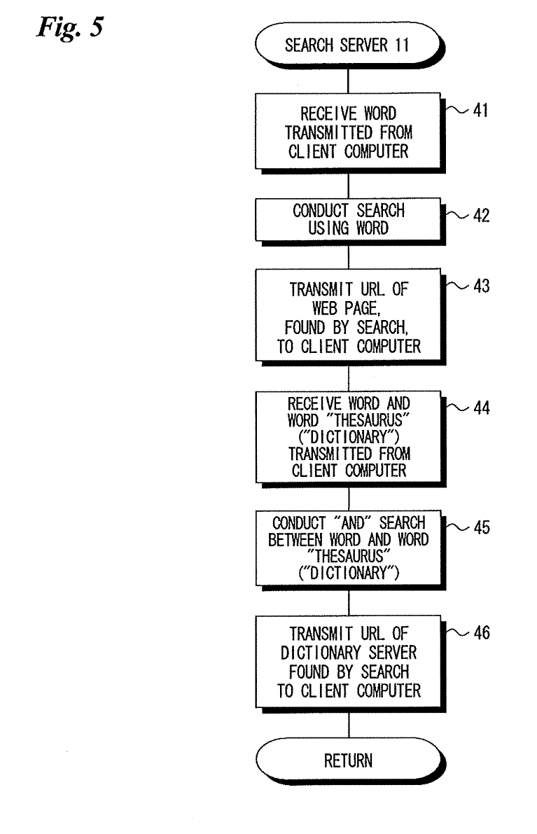

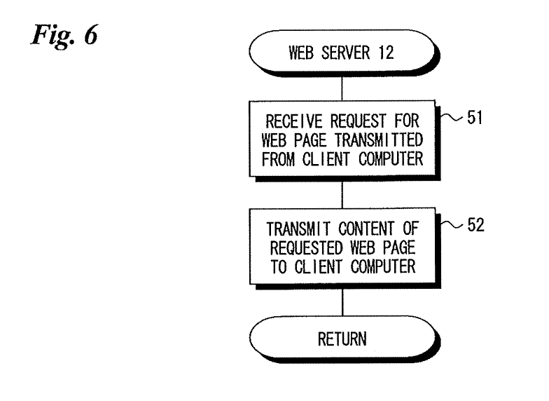

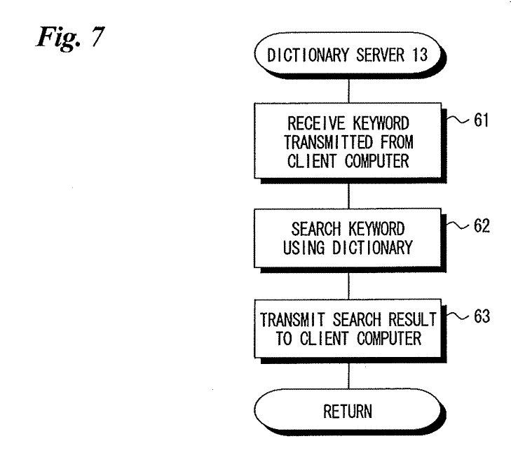

FIGS. 3 and 4 are flowcharts illustrating processing executed by the client computer 1, FIG. 5 is a flowchart illustrating processing executed by the search server 11, FIG. 6 is a flowchart illustrating processing executed by the web server 12, and FIG. 7 is a flowchart illustrating processing executed by the dictionary server.

In this embodiment, a word for finding a related keyword is input from the client computer 1. The input word is transmitted to the search server 11, which proceeds to find web pages related to the input word and extracts keywords described in meta tags of the found web pages. If an extracted keyword is described in the dictionary server 13 of a specialized dictionary in a field the same as that of the input word, then the search server 11 decides upon this keyword as a keyword related to the word that has been input to the client computer 1. In this embodiment, the dependency parsing server 14 is not used but it may be so arranged that the dependency parsing server 14 is used in a manner described later.

Using the input unit 5 of the client computer 1, the user of the client computer 1 inputs a word for deciding a related keyword (FIG. 3, step 21). Data representing the input word is transmitted from the client computer 1 to the search server 11 (FIG. 3, step 22). For example, if “C++” has been input as the word, the data representing “C++” is transmitted from the client computer 1 to the search server 11.

The word data transmitted from the client computer 1 is received by the search server 11 (FIG. 5, step 41). In response, the search server 11 conducts a search to find a number of web pages related to the word represented by the received word data (FIG. 5, step 42). The search server 11 transmits data representing the URLs of the web pages, which have been found by the search, to the client computer 1 (FIG. 5, step 43). If “C++” has been input as the word, as mentioned above, then web pages related to “C++” are found by the search.

Data representing the URLs transmitted from the search server 11 are received by the client computer 1 (FIG. 3, step 23). When this occurs, a web page specified by a desired URL is selected by the user from among the URLs represented by the received URL data. A request for the selected web page is transmitted from the client computer 1 to the web server 12 (FIG. 3, step 24). Site names of web pages linked to the URL are displayed on the display screen of the display unit 3 of the client computer 1, and a desired site is selected from among these site names, whereby a request for the web page is transmitted from the client computer 1 to the web server 12.

The request for the web page transmitted from the client computer 1 is received by the web server 12 (FIG. 6, step 51). In response, web page content representing the requested web page is transmitted from the search server 11 to the client computer 1 (FIG. 6, step 52). The request also contains the URL of the requested web page, and it goes without saying that web page content representing the web page specified by this URL (the web page stored at the specified storage location) is transmitted from the web server 12 to the client computer 1.

The web page content transmitted from the search server 11 is received by the client computer 1 (FIG. 3, step 25). When this occurs, the client computer 1 extracts a keyword described in the meta tag of an html document represented by an html (HyperText Markup Language) file contained in the received web page content (FIG. 3, step 26).

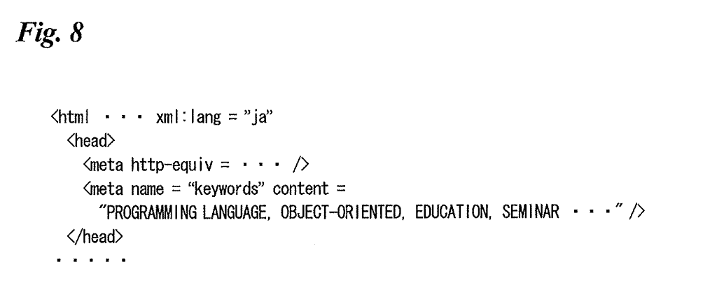

FIG. 8 illustrates part of an html document.

The header of the html document includes a meta tag (meta name=“keywords”) in which keywords are described. As for the contents of the meta tag, “programming language, object-oriented, education, seminar”, etc., are described as the keywords.

If it is assumed that “C++” has been input as a word, as mentioned above, the keywords described in the meta tag of the web page related to the word “C++” will be the above-cited “programming language, object-oriented, education, seminar”, etc. as the keywords. These keywords “programming language, object-oriented, education, seminar”, etc., are keyword candidates related to the word “C++” that has been input.

In FIG. 4, the input word (e.g., “C++”) and the word “thesaurus” (or “dictionary” or “lexicon”) are transmitted from the client computer 1 to the search server 11 (step 27).

The word and the word “thesaurus” transmitted from the client computer 1 are received by the search server 11 (FIG. 5, step 44). Upon receiving these, the search server 11 conducts an AND search between the received word “C++” and the word “thesaurus” (FIG. 5, step 45).

A web page of the search server 11 related to “thesaurus” is found by the AND search. Further, since the AND search finds a web page of the dictionary server 13 regarding “thesaurus” relating to both the word and “thesaurus” transmitted from the client computer 1, the dictionary server 13 found is considered to be one regarding a specialized dictionary in a field the same as that of the word “C++” transmitted from the client computer 1. Data representing the URL of the dictionary server 13 thus found is transmitted from the search server 11 to the client computer 1 (FIG. 5, step 46).

Naturally, in a case where dictionary servers 13 found by the AND search are a standard English-language dictionary server having the function of a standard English-language dictionary and a translation dictionary server having the function of a translation (Japanese-to-English, English-to-Japanese) dictionary, these are deleted from the search results and the data representing the URL of the dictionary server having the function of the specialized dictionary is transmitted from the search server 11 to the client computer 1. Further, it may be so arranged that in a case where a plurality of specialized dictionary servers have been found by the search, data representing the URL of the leading specialized dictionary server or the URLs of a plurality of specialized dictionary servers that include the leading specialized dictionary server is transmitted from the search server 11 to the client computer 1. The data of the URL of dictionary server 13 transmitted from the search server 11 is received by the client computer 1 (FIG. 4, step 28). When the data is received, the client computer 1 accesses the dictionary server 13 having the URL represented by the received URL data and the data representing a keyword (e.g. “programming language”) is transmitted from the client computer 1 to the dictionary server 13 (FIG. 4, step 29).

The data representing the keyword (e.g., “programming language”) transmitted from the client computer 1 is received by the dictionary server 13 (FIG. 7, step 61), whereupon the meaning and usage, etc., of the word represented by the received data representing the keyword are searched for in the dictionary (FIG. 7, step 62). The search result is transmitted from the dictionary server 13 to the client computer 1.

The search result transmitted from the dictionary server 13 is received by the client computer 1 (FIG. 4, step 30). If the keyword has been registered in the dictionary server 13 (“YES” at step 31 in FIG. 4), then it is construed that the input word (“C++”) and the keyword (“programming language”) belong to the same field. Accordingly, this keyword is decided upon as the keyword related to the input word (FIG. 4, step 32). The keyword decided is stored in the tag information database 6 in association with the word. If the keyword has not been registered in the dictionary server 13 (“NO” at step 31), then it is construed that this keyword belongs to a field different from that of the input word. This keyword is not decided upon as a keyword related to the input word. For example, if the keyword is “education”, it is construed that this keyword has not been registered in a specialized dictionary (e.g., an IT thesaurus) in the field of the input word (“C++”) and therefore the keyword “education” is not a keyword related to the input word (“C++”).

If there is a keyword that is next (FIG. 4, step 33), then processing from step 29 in FIG. 4 is executed again. If there are a plurality of web pages related to the initially input word and there is a next keyword (“YES” at step 34 in FIG. 4), processing from step 24 of FIG. 3 is executed with regard to the next web page.

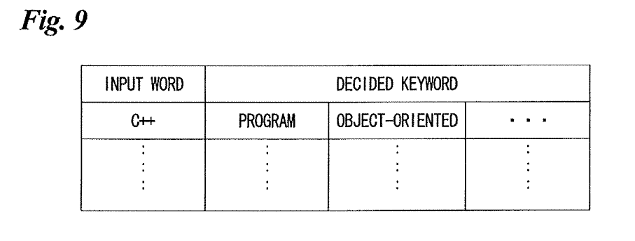

FIG. 9 is an example of a keyword table that has been stored in the tag information database 6.

Keywords decided in the manner described above have been stored in the keyword table in correspondence with words that have been input. For example, if the input word is (“C++”), then “programming language” and “object-oriented”, etc., are stored as decided keywords. The keywords thus decided can be described in the meta tag of the web page.

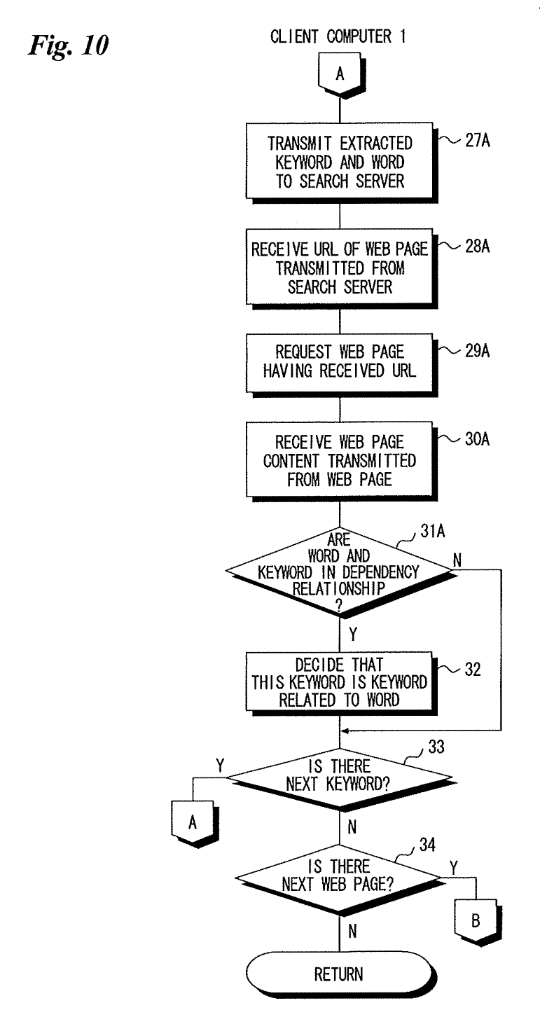

FIGS. 10 to 12 illustrate another embodiment of the present invention.

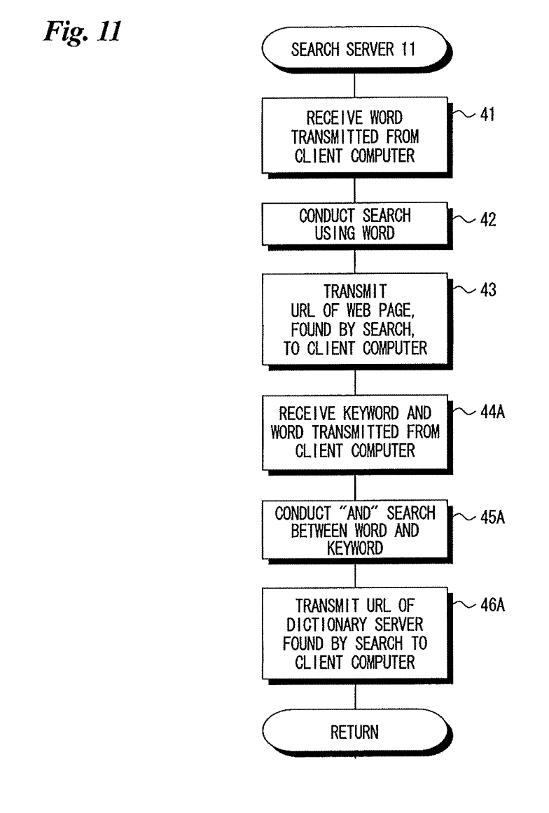

FIG. 10 is a flowchart illustrating a part of processing executed by the client computer 1 and corresponds to the processing shown in FIG. 4. FIG. 11 is a flowchart illustrating processing executed by the search server 11 and corresponds to the processing shown in FIG. 5. Processing steps in FIGS. 10 and 11 identical with those shown in FIGS. 4 and 5 are designated by like step numbers and need not be described again.

In this embodiment, it is determined whether a word that has been input and a keyword that has been extracted from a meta tag in the manner described above are in a syntactic dependency relationship and, if the input word and keyword are in such a dependency relationship, it is determined that this keyword is related to the input word. “Dependency” indicates what kind of relationship exists between a clause (word) and another clause (word). For instance, examples of relationships are a relationship comprising a subject and a predicate, a relationship between a modifier and what is modified, an auxiliary relationship, a parallel relationship and a relationship between a connector and what is connected. It goes without saying that the determination as to whether there is dependency can utilize well-known parsing methods.

First, the extracted keyword (e.g., “programming language”) and the input word (e.g., “C++”) are transmitted from the client computer 1 to the search server 11 (FIG. 10, step 27A).

The keyword and word transmitted from the client computer 1 are received by the search server 11 (FIG. 11, step 44A), whereupon an AND search between the received keyword and word are conducted by the search server 11 (FIG. 11, step 45A). Data representing the URL of a web page found by the search is transmitted from the search server 11 to the client computer 1 (FIG. 11, step 46A).

The URL data transmitted from the search server 11 is received by the client computer 1 (FIG. 10, step 28A), whereupon the web server 12 is requested for the web page of the URL represented by this URL data (FIG. 10, step 29A). Web page content representing the requested web page is transmitted from the web server 12 and is received by the client computer 1 (step 30A).

It is determined whether the word that has been input and the extracted keyword are in a dependency relationship in text contained in the web page represented by the received web page content (FIG. 10, step 31A). If these are in a dependency relationship (“YES” at step 31A in FIG. 10), then it is construed that the input word and the extracted keyword are closely related. Accordingly, this keyword is decided upon as a keyword related to the input word (FIG. 10, step 32). If the word and keyword are not in a dependency relationship (“NO” at step 31A in FIG. 10), then this keyword is not decided upon as a keyword related to the input word. If there is a next word (“YES” at step 33A), processing from step 27A is executed.

In the foregoing embodiment, dependency parsing is carried out in the client computer. However, it goes without saying that it may be so arranged that this is executed in the dependency parsing server 14. In a case where dependency parsing is performed in the dependency parsing server 14, the input word, the extracted keyword and detected web page content, etc., are transmitted from the client computer 1 to the dependency parsing server 14.

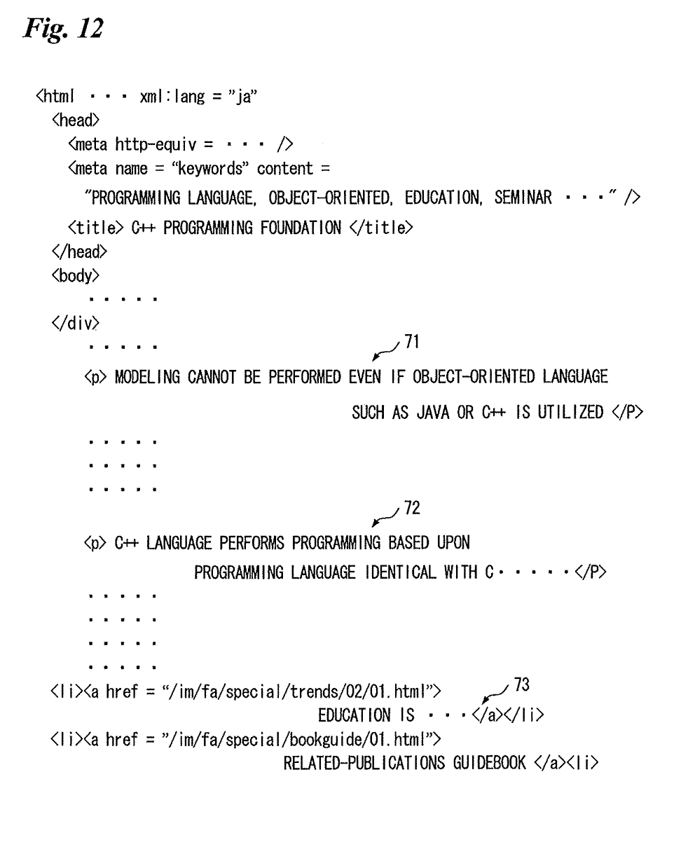

FIG. 12 illustrates an example of an html document. This html document is represented by an html file contained in web page content transmitted from the web server (the processing at step 30A in FIG. 10), as described above.

As mentioned above, it is assumed that the word that has been input is “C++” and that the extracted keywords are “programming language”, “object-oriented”, “education” and “seminar”.

The html document includes text indicated at reference numerals 71, 72 and 73, and the web page also includes the text indicated at reference numerals 71, 72 and 73.

The input word “C++” acts upon the keyword “object-oriented” in the text 71. Further, the input word “C++” acts upon the keyword “programming language” in the text 72. Accordingly, the input word “C++” and the keywords “object-oriented” and “programming language” are in a dependency relationship. The keywords “object-oriented” and “programming language” are decided upon as keywords relating to the input word “C++”.

In the text 73, the input word “C++” and the keyword “education” do not exist in the same sentence but exist at different locations. Accordingly, it is determined that these are not in a dependency relationship.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for deciding a word-related keyword, comprising:
a word input device for inputting a word for finding a related keyword;
a word data transmitting device for transmitting word data, which represents the word that has been input from said word input device, to a search engine;
a URL data receiving device for receiving URL data indicating a search result from the search engine;
a request transmitting device for transmitting a request for web page content, which represents a web page having the URL represented by the URL data received by said URL data receiving device, to a web server;
a web page content receiving device for receiving the web page content, which has been transmitted from the web server;
a keyword extracting device for extracting a keyword, which is described in a meta tag of the web page content, from the web page content received by said web page content receiving device;
a determination device for determining whether the keyword extracted by said keyword extracting device has been registered at a site of a specialized dictionary, which is a dictionary in the field of the word that has been input from said word input device; and
a keyword deciding device, responsive to a determination by said determination device that the keyword extracted by said keyword extracting device has been registered at the site of the specialized dictionary, for deciding that the keyword extracted by said keyword extracting device is a keyword of the word that has been input from said word input device.

2. The apparatus according to claim 1, wherein said determination device includes a dictionary site search device for finding dictionary sites by conducting an AND search in the search engine between the word that has been input from said word input device and the word “lexicon” or “dictionary”;
said determination device determines whether the keyword has been registered at the dictionary sites, which have been found by the dictionary site search device, except at standard English-language dictionary sites and translation dictionary sites among the found dictionary sites.

3. An apparatus for deciding a word-related keyword, comprising:
a word input device for inputting a word for finding a related keyword;
a word data transmitting device for transmitting word data, which represents the word that has been input from said word input device, to a search engine;
a URL data receiving device for receiving URL data indicating a search result from the search engine;
a request transmitting device for transmitting a request for web page content, which represents a web page having the URL represented by the URL data received by said URL data receiving device, to a web server;
a web page content receiving device for receiving the web page content, which has been transmitted from the web server;
a keyword extracting device for extracting a keyword, which is described in a meta tag of the web page content, from the web page content received by said web page content receiving device;
a first determination device for determining whether the word that has been input from said word input device and the keyword extracted by said keyword extracting device are in a dependency relationship in text contained in the web page represented by the web page content received by said web page content receiving device; and
a keyword deciding device, responsive to a determination by said first determination device that the word and keyword are in a dependency relationship, for deciding that the keyword extracted by said keyword extracting device is a keyword of the word that has been input from said word input device.

4. The apparatus according to claim 3, further comprising a second determination device for determining whether the word that has been input from said word input device and the keyword extracted by said keyword extracting device are in a dependency relationship in text contained in a web page of a search result obtained by conducting an AND search in the search engine between the word that has been input from said word input device and the keyword extracted by said keyword extracting device;
said keyword deciding device, in response to a determination by said second determination device that the word and the keyword are in a dependency relationship, deciding that the keyword extracted by said keyword extracting device is a keyword of the word that has been input from said word input device.

5. A method of controlling operation of an apparatus for deciding a word-related keyword, comprising the steps of:
inputting a word for finding a related keyword;
transmitting word data, which represents the word that has been input, to a search engine;
receiving URL data indicating a search result from the search engine;
transmitting a request for web page content, which represents a web page having the URL represented by the URL data received, to a web server;
receiving the web page content, which has been transmitted from the web server;
extracting a keyword, which is described in a meta tag of the web page content, from the web page content received;
determining whether the extracted keyword has been registered at a site of a specialized dictionary, which is a dictionary in the field of the word that has been input; and
responsive to a determination that the extracted keyword has been registered at the site of the specialized dictionary, deciding that the extracted keyword is a keyword of the word that has been input.

6. A method of controlling operation of an apparatus for deciding a word-related keyword, comprising the steps of:
inputting a word for finding a related keyword;
transmitting word data, which represents the word that has been input, to a search engine;
receiving URL data indicating a search result from the search engine;
transmitting a request for web page content, which represents a web page having the URL represented by the URL data received, to a web server;
receiving the web page content, which has been transmitted from the web server;
extracting a keyword, which is described in a meta tag of the web page content, from the web page content received;
determining whether the word that has been input and the extracted keyword are in a dependency relationship in text contained in the web page represented by the web page content received; and
responsive to a determination that the word and keyword are in a dependency relationship, deciding that the extracted keyword is a keyword of the word that has been input.

7. A recording medium storing a computer-readable program for controlling a computer of an apparatus for deciding a word-related keyword, said program controlling the computer so as to:
input a word for finding a related keyword;
transmit word data, which represents the word that has been input, to a search engine;
receive URL data indicating a search result from the search engine;
transmit a request for web page content, which represents a web page having the URL represented by the URL data received, to a web server;
receive the web page content, which has been transmitted from the web server;
extract a keyword, which is described in a meta tag of the web page content, from the web page content received;
determine whether the extracted keyword has been registered at a site of a specialized dictionary, which is a dictionary in the field of the word that has been input; and
responsive to a determination that the extracted keyword has been registered at the site of the specialized dictionary, decide that the extracted keyword is a keyword of the word that has been input.

8. A recording medium storing a computer-readable program for controlling a computer of an apparatus for deciding a word-related keyword, said program controlling the computer so as to:
input a word for finding a related keyword;
transmit word data, which represents the word that has been input, to a search engine;
receive URL data indicating a search result from the search engine;
transmit a request for web page content, which represents a web page having the URL represented by the URL data received, to a web server;
receive the web page content, which has been transmitted from the web server;
extract a keyword, which is described in a meta tag of the web page content, from the web page content received;
determine whether the word that has been input and the extracted keyword are in a dependency relationship in text contained in the web page represented by the web page content received; and
responsive to a determination that the word and keyword are in a dependency relationship, decide that the extracted keyword is a keyword of the word that has been input.
